(19) United States
(12) Patent Application Publication
(10) Pub. No.: US 2011/0019277 A1
(43) Pub. Date: Jan. 27, 2011

(54) ANTI-REFLECTIVE COATING

(76) Inventors: Brian M. Sager, Menlo Park, CA (US); James R. Sheats, Palo Alto, CA (US)

Correspondence Address: Director of IP, 5521 Hellyer Avenue, San Jose, CA, 95138, US

(21) Appl. No.: 12/741,919

(22) PCT Filed: Nov. 10, 2008
(86) PCT No.: PCT/US08/82960

§ 371 Date: Aug. 16, 2010

Related U.S. Application Data
(60) Provisional application No. 60/986,442, filed on Nov. 8, 2007.
(60) Provisional application No. 60/987,766, filed on Nov. 13, 2007.

(51) Int. Cl. G02B 1/11; B05D 5/00

(52) U.S. Cl. 359/580; 427/75; 427/243; 977/834; 977/948; 977/890

(57) ABSTRACT

Methods and devices are provided for improved anti-reflective coatings. Non-vacuum deposition of transparent conductive electrodes in a roll-to-roll manufacturing environment is disclosed. In one embodiment of the present invention, a device is provided comprising a multi-layer anti-reflective coating formed over a substantially transparent substrate; wherein the multi-layer anti-reflective coating comprises of a plurality of nanostructured layers, wherein each of the layers has a tuned porosity and at least some of the nanostructured layers have different porosities to create a different index of refraction for those layers. In some embodiments, the absorber layer for use with this anti-reflective layer is a group IB-IIIA-VIA absorber layer.

### FIELD OF THE INVENTION

This invention relates generally to coatings. More specifically, it relates to anti-reflective coatings for photovoltaic devices and/or modules.

### BACKGROUND OF THE INVENTION

Anti-reflective or antireflection (AR) coatings are designed to reduce reflection at an optical interface, thus potentially increasing light absorbance beyond that interface. AR coatings typically consist of transparent thin-film stacks comprised of alternating layers of contrasting refractive index, where the layer thicknesses result in destructive interference in the beams reflected from the optical interface, and concurrently, in constructive interference in the corresponding transmitted light.

AR coatings typically depend on an intermediate layer in the AR stack not only for direct reduction of the reflection coefficient but also leveraging the interference phenomena generated by a thin layer. For an exact quarter-wavelength coating, the incident beam, when reflected from the second interference interface, will travel a distance equal to half its wavelength, this distance being further than the light hitting the first surface. If both light paths have the same intensity, then they will be out of phase 180 degrees and total destructive interference arises from that light path interaction. Thus there would be no reflection from the surface, and all the light will be transmitted through the interference interface. This is the basis of an idealized AR coating.

There are several AR coating architectures, including single-layer coatings, multi-layer coatings, and, and nanostructured coatings.

Single-layer coatings are typically comprised of a single quarter-wave layer of optically transparent material whose refractive index is the square root of the substrate's refractive index. This should result in zero reflectance at the center wavelength and decreased reflectance for wavelengths in a band around the center wavelength. For example. Crown glass has an index of refraction of about 1.52, so an ideal single layer AR coating would have an index of about 1.23, and there are no bulk materials that have an index near that value. An approximate match can be found with the material magnesium fluoride, which has an index of about 1.38. For crown glass, a ˜150 nm MgF2 layer results in a reflectance of about 1%, which is 4× better than the 4% reflection of bare crown glass.

Multi-layer coatings can be formed by depositing alternating layers of a low index material with a higher index material, with reflectivity reductions possible as low as 0.1% at a single wavelength. Broad band reduction in reflectance can be enhanced with more complex and expensive AR stack architectures. Further improvements in AR function are possible by use of multilayer stacks that generate maximum destructive interference from the various surfaces within the stack. For example, a second quarter wavelength thick layer could be formed between a low index layer and another surface, where the reflections from three or more interfaces produce additional destructive interference.

Mechanical etching at the nanoscale can create a rough surface which can function as an AR coating. For example, acid etching of soda lime glass can alter the index of refraction to around 1.27, due to the air pockets formed between the etched grooves and valleys in the glass. However, acid etching is an aggressive strategy for a high volume manufacturing process where waste disposal is critical and where minimal environmental impact is sought.

More ordered nanostructured coatings can be used to approach an appropriately low refractive index where the coating material is thinned by air, so porosity is the tuning mechanism to achieve an optimum aggregate index of refraction. One approach to achieving this porosity is to sinter together similarly sized SiO2 nano-scale spheroids with a sol to promote inter-particle adhesion (DE 199 18 811 A1). In this case the voids between the loosely formed particle coating provide air pockets which reduce the aggregate index of refraction. However, these coatings have been found to be prone to mechanical attack by abrasion, and their long-term durability is thus low.

Alternatively, a porous AR coating can be achieved with sols formed using aqueous systems with less than 1% organic components, where the AR properties are excellent, mechanical strength is high, and anti-abrasion properties are good (U.S. Pat. No. 7,128,944 B2 to Becker at al.). However, the coating formation process results in structural inhomogeneities as exemplified by streaking across the coated substrate, which can impact both the function and the appearance of the coated film.

Another approach to nanostructured AR coatings makes use of two sizes of SIO2 nano-scale spheroids, where the smaller particles contribute both to an altered index of refraction and to good sintering (and thus uniform thickness with minimal streaking) due to the high chemical reactivity afforded by the high surface area to volume ration of very small particles (4-15 nm), and where the large particles contribute both to an altered index of refraction, to chemical adhesion to the underlying glass, and to good optical properties for a tuned AR functionality (see US 2004/0258929). However, the formation process using two or more particle sizes is prone to inhomogeneous coating formations, especially if like particles aggregate together. Clumping can result in streaking and other optical defects including reduced AR functionality. Moreover, the coating process is relatively complex, with the requirement for nearly uniform application of three discrete coating components (sol, small particle, large particle), and the need to have uniform mixing of these particles and sol prior to and during the coating process.

### SUMMARY OF THE INVENTION

Embodiments of the present invention address at least some of the drawbacks set forth above. In some embodiments, the present invention provides for the use of sol-gel based chemical processes to form an anti-reflective coating. This may be used with rigid substrates and/or flexible substrates. At least some of these and other objectives described herein will be met by various embodiments of the present invention.

In one embodiment of the present invention, a device is provided comprising a multi-layer anti-reflective coating formed over a substantially transparent substrate; wherein the multi-layer anti-reflective coating comprises of a plurality of nanostructured layers, wherein each of the layers has a tuned porosity and at least some of the nanostructured layers have different porosities to create a different index of refraction for those layers.

It should be understood that embodiments of the present invention may modified to include one or more of the following features. In one embodiment, the multi-layer anti-reflective coating has a graded index of refraction. Optionally, each of the nanostructured layers has a different index of refraction. Optionally, the porosity of each layer is different from the porosity in any other layer to alter an index of refraction for that layer. Optionally, the nanostructured porous layers define a three-dimensional porous network that provides an optical path which captures most of the visible light which enters the network. Optionally, the three-dimensional porous network increases light transmission through the substantially transparent substrate to an underlying photovoltaic absorber layer. Optionally, light collection is at least 95% of incoming light in wavelengths between about 300 nm to about 1300 nm. Optionally, light collection is at least 90% of incoming light in wavelengths between about 300 nm to about 1300 nm. Optionally, light collection is at least 85% of incoming light in wavelengths between about 300 nm to about 1300 nm. Optionally, light collection is at least 95% of incoming light in wavelengths between about 400 nm to about 1600 nm. Optionally, light collection is at least 90% of incoming light in wavelengths between about 400 nm to about 1600 nm. Optionally, light collection is at least 85% of incoming light in wavelengths between about 400 nm to about 1600 nm. Optionally, the multilayer anti-reflective coating is conformal to the substrate. Optionally, pores are filled with a pore-filling material to define nanostructures in the nanostructured porous layers. Optionally, pores are filled with a pore-filling material to define nanowires in the nanostructured porous layers. Optionally, pores in at least one of the layers are filled with a transparent pore-filling material. Optionally, pores in at least one of the layers are filled with one of the following: titania (TiO2), organic material, dyes, pigments, or conjugated polymers. Optionally, at least some of the nanostructured porous layers are made of different material. Optionally, a top nanostructured porous layer of the multi-layer anti-reflective coating comprises of a different material than a bottom nanostructured porous layer. Optionally, a top nanostructured porous layer of the multi-layer anti-reflective coating comprises of a silica and a bottom nanostructured porous layer comprises of titania. Optionally, a top nanostructured porous layer of the multi-layer anti-reflective coating comprises of a titania and a bottom nanostructured porous layer comprises of silica. Optionally, each of the nanostructured porous layer is made of at least one of the following: titania (TiO.sub.2), silica (SiO.sub.2), zinc oxide (ZnO.sub.2), alumina, zirconium oxide, lanthanum oxide, niobium oxide, tungsten oxide, tin oxide, indium oxide, indium tin oxide (ITO), strontium oxide, vanadium oxide, molybdenum oxide, calcium/titanium oxide, or blends of two or more such materials. Optionally, the layers include nanostructured, self-assembled pores in the size range of about 5 nm to about 400 nm. Optionally, pores are between about 2 nm and about 500 nm in diameter, or between about 40 nm and about 100 nm in diameter or between about 10 nm and about 30 nm in diameter. Optionally, the pores comprise of tubule pores that have an average diameter between about 1 nm and about 200 nm or between about 1 nm and about 100 nm, or between about 10 nm and about 50 nm, or between about 20 nm and about 40 nm or about 30 nm. Optionally, the anti-reflective coating is formed on one or more of the following: glass, a transparent flexible substrate, a polymer substrate, soda lime glass, solar glass, tempered solar glass, tempered glass, untempered glass, a glass-foil solar module, a glass-glass solar module, a transparent rigid substrate, a transparent flexible substrate, a flexible module, or combinations of the foregoing. Optionally, a surface protecting layer is provided over the multi-layer anti-reflection coating. Optionally, a UV absorber is provided over the multi-layer anti-reflection coating. Optionally, a moisture resistance and scratch resistance layer is included. Optionally, a fluorine resin is laminated to the anti-reflection coating as a surface protecting layer. Optionally, the device further comprises at least one of the following in conjunction with the anti-reflective coating: nitrides, oxides, oxynitrides or other inorganic materials that protect against exposure to water or air. Optionally, the device further comprises an encapsulant having a multi-layer stack or a foil comprising a multi-layer stack of organic materials with inorganic dielectrics, wherein the encapsulant is in contact with the anti-reflective coating. Optionally, the device further comprises a group IB-IIIA-VIA photovoltaic absorber layer positioned to receive light from the transparent substrate.

In another embodiment of the present invention, a device is provided comprising a multi-layer anti-reflective coating formed over a substantially transparent substrate; wherein the multi-layer anti-reflective coating comprises of a plurality of nanostructured layers, wherein each of the layers a plurality of self-assembled nanostructures who have at least one dimension within a spatial scale between about 2 nm to about 50 nm.

It should be understood that embodiments of the present invention may modified to include one or more of the following features. In one embodiment, the device further comprises a group IB-IIIA-VIA photovoltaic absorber layer positioned to receive light from the transparent substrate. Optionally, the AR coating is deposited and then sandwiched between other layer to form multilayer stack where AR coating may be at any position with the stack. Optionally, the AR coating is used in broad array of optical applications including coating on lenses, cameras, microscopes, other optical devices, filters, visual displays, or flat screen displays.

In yet another embodiment of the present invention, a method of forming an anti-reflective film is provided comprising forming a plurality of nanostructured porous layers wherein a porosity of each layer is tuned by at least one of the following: a sol-gel process, surfactant templation, and/or forming nanoporous coatings from polymeric precursors and using decomposition of the organic portion by heat, plasma or ozone; wherein the nanostructured elements comprise of at least one of the following: a pore, a filled-pore, and/or a channel.

It should be understood that embodiments of the present invention may modified to include one or more of the following features. In one embodiment, each of the layers comprises a regular array of structures, the structures having diameters between about 3 nm to about 50 nm with adjacent structures spaced between about 10 nm and about 50 nm. Optionally, each of the layers comprises a regular array of structures, the structures having diameters between about 10 nm to about 50 nm with adjacent structures spaced between about 10 nm to about 50 nm. Optionally, each of the layers comprises a regular array of structures, the structures having diameters between about 10 nm and about 500 nm with adjacent structures spaced between about 10 nm and about 500 nm. Optionally, the method further comprises substantially filling the pores with a pore-filling material to define a plurality of nanostructures in the porous layer. Optionally, the method includes using an organic pore-filling materials that is provided in the form of a process solution containing a precursor material and a solvent. Optionally, each of the nanostructured porous layers are between about 50 nm and about 1 micron thick. Optionally, one embodiment of the present invention comprises filling the pores with a pore filling material to define structures in the nanostructured porous layer and removing the nanostructured porous layer leaving behind an array of structures with spaces between the structures. Optionally, the nanostructured layers are formed using a self-assembly process. Optionally, the nanostructured layers are formed using a sol-gel process. Optionally, each of the nanostructured layers are sequentially formed using a solution deposition process. Optionally, a plurality of the nanostructured layers are formed without sintering. Optionally, the anti-reflective film is formed on individual solar cells. Optionally, the anti-reflective film is formed on a substantially transparent front layer of a solar panel. Optionally, the anti-reflective film is formed directly on a solar cell with no glass at all on the cell.

In a still further embodiment of the present invention, a method of forming an anti-reflective film comprises forming a first nanostructured layer having a first porosity; changing pore diameter and forming a second nanostructured layer having a second porosity; changing pore diameter and forming a third nanostructured layer having a third porosity, wherein each layer has a different index of refraction due to different pore sizes; wherein a porous network defined by combining the layers above provides an optical path which captures most of the visible light which enters the network.

In another embodiment of the present invention, a device is provided comprising a single layer anti-reflective coating formed over a substantially transparent substrate; wherein the anti-reflective coating comprises of a plurality of self-assembled nanostructures who have at least one dimension within a spatial scale between about 2 nm to about 50 nm. Optionally, the nanostructures are pores. Optionally, the nanostructures may be but are not limited to filled pores, nanowires, nanorods, or interconnected network of pores (filled, partially filled, or unfilled).

In yet another embodiment, a method of forming an anti-reflective film is provided comprising forming a single nanostructured porous layer wherein a porosity of the layer is tuned by at least one of the following: a sol-gel process, surfactant templation, and/or forming nanoporous coatings from polymeric precursors and using decomposition of the organic portion by heat, plasma or ozone; wherein the nanostructured elements comprise of at least one of the following: a pore, a filled-pore, and/or a channel.

A further understanding of the nature and advantages of the invention will become apparent by reference to the remaining portions of the specification and drawings.

### BRIEF DESCRIPTION OF THE DRAWINGS

FIG. 1 is side view of a system according to one embodiment of the present invention.

FIG. 2 is a top down view of a system according to one embodiment of the present invention.

FIG. 3 shows a solution deposition system according to one embodiment of the present invention.

FIG. 4 shows a nanostructured layer according to one embodiment of the present invention.

### DESCRIPTION OF THE SPECIFIC EMBODIMENTS

It is to be understood that both the foregoing general description and the following detailed description are exemplary and explanatory only and are not restrictive of the invention, as claimed. It may be noted that, as used in the specification and the appended claims, the singular forms “a”, “an” and “the” include plural referents unless the context clearly dictates otherwise. Thus, for example, reference to “a material” may include mixtures of materials, reference to “a compound” may include multiple compounds, and the like. References cited herein are hereby incorporated by reference in their entirety, except to the extent that they conflict with teachings explicitly set forth in this specification.

In this specification and in the claims which follow, reference will be made to a number of terms which shall be defined to have the following meanings:

“Optional” or “optionally” means that the subsequently described circumstance may or may not occur, so that the description includes instances where the circumstance occurs and instances where it does not. For example, if a device optionally contains a feature for an anti-reflective film, this means that the anti-reflective film feature may or may not be present, and, thus, the description includes both structures wherein a device possesses the anti-reflective film feature and structures wherein the anti-reflective film feature is not present.

Overcoming the challenges summarized in the prior art, some embodiments of the present invention comprises of an AR coating which is easily processed with minimal environmental impact upon high production volume manufacturing, which is mechanically stable and abrasion resistant, uniformly formed even on large surface areas, and simply processed without the need for silica nanoparticles or mixtures of different silica nanoparticles of different sizes and/or functions. Moreover, the manufacturing process can be carried out on either tempered or non-tempered glass substrates, at low temperatures (200 C or less), and with highly structured coating whose uniformity is high at the macro-, meso-, and nanoscale-.

One embodiment of the present invention involves the formation of a surfactant-templated, pore-swelled sol gel coating whose pore diameter can be made highly uniform and tuned from about 3 nm to more than about 50 nm. By changing the pore diameter, the total void volume in the bulk coating can be tuned to achieve a near ideal index of refraction, while the three-dimensional nature of the as-formed porous network provides an optical path which captures most of the visible light which enters the network. The device has a more ordered surface structure than the acid-etched roughness of the prior art, a higher uniformity than the aqueous sol coating of other prior art, and a simpler manufacturing process than the sol-gel embedded, multi-modal nanoparticle strategy employed in still other prior art.

In particular, the disadvantages associated with the prior art are overcome by embodiments of the present invention directed to a method for making an nanostructured AR layer on glass, and glass AR devices having such a nanostructured layer. In one embodiment of the method, a precursor sol is disposed on a substrate. The precursor sol generally includes one or more covalent metal complexes with a central element X, one or more surfactants, and one or more solvents. The precursor sol may optionally include one or more condensation inhibitors and/or water. The solvent is evaporated from the precursor sol to form a surfactant-templated film. The size of one or more pores formed in the surfactant-templated film is controlled such that the pores have diameters between about 10 nm and about 50 nm with adjacent pores spaced between about 10 nm and about 50 nm. The size of the pores may be controlled, e.g., by appropriate concentration of the solvent, the choice of surfactant, use of a chelating agent, and/or a swelling agent. The surfactant-templated film is covalently crosslinked to form a nanostructured porous layer based on a compound of central element X. As a result of control of the pore size in the surfactant templated porous film, the nanostructured porous layer has pores with diameters between about 10 nm and about 50 nm with adjacent pores spaced between about 10 nm and about 50 nm. Examples of surfactant-templation techniques for producing porous films are described, e.g., by rinker, et al in U.S. Pat. No. 6,270,846, and by U.S. patent application Ser. No. ______ (attorney docket no. NSL-010) filed ______, both of which are incorporated herein by reference.

The precursor sol generally includes one or more covalent metal complexes with a central element X, one or more surfactants, one or more condensation inhibitors, water, and a solvent. The solvent can be a polar organic solvent or any other solvent that solubilizes the other reactants. Examples of suitable solvents include alcohols, (e.g., methanol, ethanol, propanol, butanol, isopropanol), tetrahydrofuran, formamide, dimethylformamide or mixtures thereof. The covalent metal complexes can be metal alkoxides and/or metal halides nitrides etc.

For SiO₂-based surfactant templated films examples of suitable alkoxides include polysiloxanes such as tetraethylorthosilicate (TEOS).

For TiO₂-based porous surfactant templated films examples of suitable covalent metal complexes include alkoxides such as titanium ethoxide or titanium isopropoxide, titanium chloride, titanium butoxide, titanium (AcAc) (i.e., titanium diisopropoxide(bis-2,4-pentanedionate)), titanium methacryloxyethylacetoacetate triisopropoxide, and titanium bis(triethanolamine) diisopropoxide and the like.

Examples of suitable surfactants include HO(CH₂CH₂O)ₙ(CH₂CHCH₃O)ₘCH₂CH₂O)ₙH, where the subscripts m and n are integers. A particular surfactant of this type is the block copolymer poly(ethyleneoxide)-poly(propyleneoxide)-poly(ethyleneoxide) (EO20-PO70EO20), sometimes known commercially as Pluronic P123. For Pluronic P123, n=20, m=70, n=20 and the nominal molecular weight is 5750 g/mol. Pluronic F127, is a triblock copolymer (PEO-PPO-PEO, having an n-m-n ratio of PEO106PO70EO106, i.e., n=106, m=70, n=106. The nominal molecular weight for Pluronic F127 is 12,600 g/mol. P123 and F127 are difunctional block copolymer surfactants terminating in primary hydroxyl groups. They are nonionic surfactants. Other suitable surfactants include hexadecyl trimethylammonium bromide (CTAB), polyoxyalkylene ether, and poly(oxyethylene) cetyl ether (e.g., Brij56 or Brij58) Pluronic is a registered trademark of BASF Corporation of Ludwigshafen, Germany. Brij is a registered trademark of Atlas Chemicals of Wilmington Del. Brij 56 is polyoxyethylene 10 cetyl ether. Brij 58 has several synonyms, including poly(oxyethylene) cetyl ether, poly(oxyethylene) palmityl ether, polyethylene oxide hexadecyl ether, and polyethylene glycol cetyl ether.

Examples of suitable condensation inhibitors include acids such as hydrochloric acid (HCl), sulfuric acid (H₂S0₄), nitric acid (HNO₃), carboxylic acids, such as acetic acid (HOAc), and the like, bases such as sodium hydroxide (NaOH), ammonium hydroxide (NH₄OH) triethylamine, and the like, and chelating agents, such as ketones, B-diketones, carboxylic acids, B-keto-carboxylic acids, diols, aminoalcohols, crown ethers, hydroxyl or amine containing polymers, small molecules or cosolvents such as ethyl acetoacetate, 2-4-pentadione, acetone, diacetone alcohol, chatecol, stearic acid, lactic acid, chatechol, ethanolamine, triethanolamine and the like.

Generally speaking, the molar ratios of the surfactant, condensation inhibitor, ethanol and water may be in the following ranges with respect to the central element X, where X refers to the central element or inorganic network atom in the covalent metal complex:

[Surfactant]/[X]: a molar ratio ranging from about 1×10⁻⁷ to about 0.1

[Solvent]/[X]: a molar ratio ranging from about 3 to about 50

[Condensation Inhibitor]/[X]: a molar ranging ratio from about 1×10⁻⁵ to about 5

[water]/[X]: a molar ratio ranging from about 0 to about 20.

The sol may be filtered and a thin film prepared from this solution may be disposed on a substrate by spin-coating, web-coating, dip-coating, spray-coating, ink jet printing, doctor blade coating, spray coating, printing such as screen-printing, ink jet printing, flexographic printing, gravure printing, micro-gravure printing, and the like. In some embodiments, the substrate may be an electrode. In such a case, the precursor sol may be disposed directly on the surface of the electrode, or the surface of an intervening layer.

The solvent is evaporated from the precursor sol to form a surfactant-templated film. Evaporation of the solvent causes the formation of surfactant-stabilized microemulsions or micelles that are precursors to a surfactant stabilized film.

The size of one or more pores formed in the surfactant-templated film is controlled such that the pores have diameters between about 10 nm and about 50 nm with adjacent pores spaced between about 10 nm and about 50 nm measured, e.g., by the thickness of the walls of the pores.

Pore diameter and pore spacing in the surfactant templated film may be adjusted by (1) choice of surfactant, (2) concentration of surfactant, (3) the use of block co-polymers, (4) temperature, (5) humidity level, (6) deposition procedure and speed, (7) concentration of covalent metal complex, (8) use of a cosolvent, (9) use of swelling agents, (10) use of chelating agents, (11) use of acids, (12) use of bases, (13) the nature of the covalent metal complex, e.g., in terms of type and nature of ligands attached, or some combination of two or more of (1), (2), (3), (4), (5), (6), (7), (8), (9), (10), (11), (12), and (13). Of particular interest are techniques for controlling the pore diameter and pore spacing based on (2), (3), (7), (9) and (10).

In general, increasing surfactant, increasing solvent, and addition of pore-swelling agents tend to increase pore size. The use of condensation inhibitors that can function as chelators will also tend to increase pore size. Furthermore, a greater alkoxide concentration tends to lead to greater thickness for the walls of the pores and, therefore, greater pore spacing. However, other factors can influence pore spacing.

With respect to (3), surfactant templated thin films having larger pore sizes, e.g., between about 10 nm and about 50 nm may be obtained by using large block co-polymers as surfactants. Generally speaking the larger the surfactant the larger the pore size. For example, where the surfactant is a block co-polymer having a molecular weight greater than about 5000 grams/mole. The upper bound for the molecular weight of the block copolymer depends partly on its solubility in the solvent used in the sol. One possible range of molecular weights is between about 5000 grams/mole and about 15,000 grams per mole. An example is a block co-polymer of the type (EO)106(PO)70(EO)106, with a molecular weight of 12,600. It is also possible to mix two or more different kinds of surfactants in the sol to modulate the pore size.

With respect to (9), swelling agents such as oils can be used to push out the size of the pore during surfactant templation. In general, where the surfactant is hydrophobic on the inside of the pore and hydrophilic on the outside of the pore. The addition of hydrophobic molecules to the precursor sol tends to increase the pore diameter during templation. Examples of suitable hydrophobic molecules include trimethylbenzene (TMB), catechols, polypropylene glycols, tween triton, butanol, hexanol, octanol, octane, isooctane, formamide, and latex. Additionally pores can be enlarged by mixing diblock copolymers, triblock copolymers or one of the preceding hydrophobic or oily molecules with a standard surfactant. Preferably the pore-swelling agent (PSA) is in a molar ratio [PSA]1/[X] of between about 0 and about 5.

In the prior art, pore swelling agents have been used to make materials with larger pores. However, these materials have typically been powders or ceramic materials as opposed to the surfactant templated films or nanostructured porous layers as described herein.

With respect to (10), the use of chelating agents is a preferred technique for controlling pore size or structure or controlling acidity. Chelating agents can be added to the existing sol chelating to the central element X in the sol. Alternatively, the sol can be prepared as a clean chelated-X complex used in the sol. Chelating agents can affect the bonding of the central element X and thereby modulate the pore size during surfactant templation. A chelating agent is a substance whose molecules can form one or more coordinate bonds to a single metal ion. The most common and most widely used chelating agents are those that coordinate to metal ions through oxygen or nitrogen donor atoms, or through both.

Examples of suitable chelating agents include compounds from the family of ketones, B-diketones, carboxylic acids, B-keto-carboxylic acids, diols, aminoalcohols, crown ethers, hydroxyl or amine containing polymers, small molecules or cosolvents such as ethyl acetoacetate, 2-4-pentadione, acetone, diacetone alcohol, chatecol, stearic acid, lactic acid, chatechol, ethanolamine, triethanolamine and the like. Preferably the chelating agent is present in the precursor sol in a molar ratio [Chelating Agent]/[X] of between about 0.1 and about 5, more preferably, between about 1 and about 3.

Note that many of the techniques for controlling pore size and pore spacing involve the preparation of the precursor sol. As such, the acts constituting step may take place, in whole or in part, before during or after evaporating the solvent from the sol or before, during or after disposing the precursor sol on the substrate. Furthermore, some elements of controlling the pore size may occur contemporaneously with disposing the precursor sol on the substrate, or evaporating the substrate. Such elements include e.g. deposition technique, substrate or sol temperature, rate of evaporation, humidity, etc. The order of the steps described above has been chosen for the sake of clarity and should not be regarded as a limitation on any embodiment of the present invention.

### EXAMPLES OF NANOSTRUCTURED LAYER FABRICATION

### Example 1

### Increase Solvent

TiO₂-based surfactant templated films with roughly 10 nm-20 nm diameter pores can be formed from a precursor sol with increased solvent concentration. In this example, the precursor sol used titanium ethoxide as the alkoxide, Pluronic P123 or F127 as the surfactant, HCl, as the condensation inhibitor, water, and ethanol as the solvent in the following molar ratios:

[Surfactant]/[X]: from about 9×10⁻⁸ to about 1×10⁻²

[Solvent]/[X]: from about 10 to about 50

[Condensation Inhibitor]/[X]: from about 0.1 to about 3

[water]/[X]: from about 0.1 to about 10

### Example 2

### Use of a Pore-Swelling Agent

TiO₂-based surfactant templated films with roughly 10 nm-30 nm diameter pores can be formed from a precursor sol using trimethyl benzene as a pore-swelling agent (PSA). The precursor sol can use titanium ethoxide as the alkoxide, Pluronic F127 as the surfactant, HCl or HOAc, as the condensation inhibitor, water and ethanol as the solvent in the following molar ratios:

[Surfactant]/[X]: from about 9×10⁻⁸ to about 1×10⁻²

[Solvent]/[X]: from about 10 to about 50

[Condensation Inhibitor]/[X]: from about 0.1 to about 3

[water]/[X]: from about 0.1 to about 10

[PSA]/[X]: from about 0.1 to about 3

### Example 3

### Use of a Chelating Agent

TiO₂-based surfactant templated films with roughly 20 nm-50 nm diameter pores can be formed from a precursor sol using pre chelated titania or generated in situ using Acetic acid or 2,4-pentanedione as a chelating agent. Acetic acid can also serve as a condensation inhibitor. The precursor sol can use titania diisopropoxide(bis-2,4-pentadioneate) as the alkoxide, Pluronic P123 or others as the surfactant, and ethanol as the solvent in the following molar ratios:

[Surfactant]/[Ti]: from about 9×10⁻⁸ to about 1×10⁻³;

[Solvent]/[Ti]: from about 10 to about 50;

[Chelator]/[Ti]: from about 1 to about 3.

[Condensation Inhibitor]/[X]: from 0 to about 5.

### Alternative Embodiments

In addition to the use of silica coatings, titania coatings can be used, which, in addition to being similarly optically transparent, also harbor auto-catalytic self-cleaning properties that are useful to remove debris and impurities from the surface of solar glass and from solar panels.

Further, the surfactant templated porous network can be left “empty”, e.g. filled with air, or alternatively filled with another material with a particular refractive index, such as a polymer, which could be melt-infiltrated into the porous network.

Still further, the surfactant templated porous network could be used as a sacrificial mold in which to form another nanostructured film, and in which the original network material is removed, leaving the inverse structure in place as the AR coating.

Still further, yet more different materials than silica or titania could be used to form the porous network, including but not limited to any of a range of metal oxides.

Still further, different thicknesses of AR coatings could be applied as coating, ranging from a few nm to more than a micron.

In addition, more than one coating could be applied, e.g. multiple coatings could be formed onto the same glass substrate. These might be made from similar or from different precursor materials.

In addition, substrates other than glass could be used, including but not limited to polymeric and/or ceramic materials.

Finally, the three-dimensional network within the AR coating can be tuned as a multi-scale photonic device to trap the majority of the light exposed to the AR coating.

Small pores are probably advantageous for keeping dirt out (pollen, etc.) and better isolation. By way of example and not limitation, pores down to 2-3 nm have been reported with methylsilsesquioxane.

By way of nonlimiting example, a number of advances and variations may be including such as but not limited to:

a) Silsesquioxanes, especially polymethylsilsesquioxane or hydrogensilsesquioxane, but also other organic ligands besides methyl (e.g. phenyl, butyl, etc.) and copolymers thereof. These have lower refractive index than SiO2 because they are a somewhat open network. [Miller et al. at IBM pioneered the use of these for ICs. The result is a comparable refractive index with less pore fraction and hence higher mechanical strength. At lower pore fraction, the pores are more likely to be completely isolated, and hence non-penetrable by external media such as water.]

b) Copolymers of silsesquioxanes with bis(trimethoxysilyl)ethane, or bis(triethoxysilyl)ethane, which provide even greater mechanical strength.

c) Treatment of porous film with gases such as HMDS, TMDS (tetramethyldisilazane), and TMCS (trimethylchlorosilane) for hydrophobicity. Supercritical CO2 is helpful in this process, as described by B. Xie and A. J. Muscat, Microelectronic Engineering 76 (2004) 52-59.

d) Use of oxygen plasma to remove organic component at lower temperature (or faster), as an alternative to ˜400 C porogen burnout treatment.

e) Use of UV/ozone to remove organic component at lower temperature (or faster), as a similar alternative.

f) Triblock copolymers of polyisoprene and poly(pentamethyldisilylstyrene), and other block copolymers of siloxane or silane with organic backbone polymers.

g) The use of multiple layers to optimize the effect with a still low-cost technique. For example, one might, by the use of the porosity, get a coating with an index of 1.1 which still has decent strength (there is one example of such given in the literature). That would then benefit from a second layer in between it and the glass, with an index of something around 1.3. This is readily accomplished with the thin film precursor-type coatings presently disclosed, and not so readily doable (if at all) with the sintered glass sphere approach of (at least one) prior art.

Optionally, embodiments of the present invention may also claim several other ways to produce nanoporous coatings from polymeric precursors, using decomposition of the organic portion by heat, plasma or ozone. For example and not limitation, graft copolymers can be made with organic polymers (which would adopt a coiled configuration) on the side chains of siloxane polymers (which provide the silica connected network). The opposite arrangement (siloxane side chains, organic backbone) is also of course possible.

The pores 1001 in the nanostructured porous layer may optionally be filled with a pore-filling material having complementary charge transfer properties with respect to the compound of central element X that makes up the nanostructured porous layer. In some embodiments, the organic pore filling materials include materials such as perylenes, phtalocyanines, merocyanines, terylenes, squaraines, ruthenium complexes, pentacenes, naphthalocyanines, poly(phenylene), polyphenylvinylene, poly(isothianaphthene), polyfluorenes, polyparaphenylene, spirocompounds, poly(squaraine), PEDOT, poly(thiophene), polyacetylene, conjugated C-60, polyaniline, dendrimers, and their derivatives.

Generally, organic pore-filling materials may be provided in the form of a process solution containing a precursor material and a solvent. The process solution may be applied to the nanostructured porous layer by any suitable technique, e.g., web-coating, doctor blade coating, spray coating, spin coating, or a printing such as printing such as screen-printing, ink jet printing, flexographic printing, gravure printing, micro-gravure printing, and the like. Heat may be applied to the nanostructured porous layer and pore-filling material during this step, e.g., to evaporate solvents and set the pore-filling material and/or to assist material infiltration, e.g., through capillary action and/or osmotic force.

Some suitable inorganic materials include aluminum, silver, titania (TiO.sub.2), silica (SiO.sub.2), zinc oxide (ZnO.sub.2), alumina, zirconium oxide, lanthanum oxide, niobium oxide, tungsten oxide, tin oxide, indium oxide, indium tin oxide (ITO), strontium oxide, vanadium oxide, molybdenum oxide, calcium/titanium oxide, or blends of two or more such materials.

One embodiment of the present invention is the formulation of and deposition of a sol-gel into the pores, followed by air-drying then heating, e.g., at 400° C. For example, a precursor solution of titanium can be mixed with ethanol, acid, acetylacetone (AcAc), and water, the resulting mixture forms a sol and the porous template is immediately dipped into this solution for 5-120 seconds. To control the deposition morphology, either deposition time or the sol temperature can be modified. For example, 5-second deposition at 15° C. (deposition at room temperature can also work) ultimately yields hollow tubules of the material being deposited, while 60-second deposition yields solid tubes of that material. Temperature can also influence the deposition process. For example, at 5° C., thin walled hollow tubes can form even when the deposition time is extended to 120 seconds, while at 20° C., solid walled tubes can form even when the deposition time is 5 seconds.

After deposition, the film is dried in air and at room temperature for thirty seconds, then the film is heated in a controlled ramp from room temperature to 400° C. in 10 to 50° C./minute increments. At 400° C., the film is held at this temperature for six hours, then ramped down from to 400° C. to room temperature in about 10 to 50° C./minute increments.

Alternatively or in parallel, UV light and/or a plasma can be exposed to the film to provide additional energy for cross-linking and thus to reduce the temperature and time requirements for the cross-linking process.

Upon heating, TiO₂ crystals form in the pores, e.g., with their C-axis oriented along the pore axis. After heating, if any residual sol-gel resulted in surface films forming on top of the template, mechanical polishing (e.g. using fine-grain sandpaper) can be used to remove any metal oxide deposit on either side of the film surface. Alternatively, chemical, wet-chemical or plasma etch techniques or combinations thereof can be used to remove any potential undesired surface film.

In a particular example, a TiO₂ sol (5 wt %) may be prepared for use in a sol-gel based tubule formation process using titanium isopropoxide (TI)—a precursor, acetylacetone (ACAC)—a condensation inhibitor, distilled water, and ethanol (EtOH)—a solvent, mixed at mole ratios ranging as follows:

ACAC/TI from about 10⁻⁵ to about 5;

Water/TI from 0 to about 20; and

EtOH/TI from about 3 to about 50.

Other condensation inhibitors and solvents may be substituted for those listed above. Furthermore the titanium isopropoxide may be replaced with another precursor compound, e.g., an alkoxide, or chloride, derived from either titanium or another central element Prior to depositing the TiO₂ sol, the substrate may be treated to facilitate the deposition and/or coating/wetting, e.g., by plasma cleaning, UV-Ozone cleaning, wet-chemical cleaning, and the like.

The synthesis can be carried out at room temperature in air. For sol-gel coating, porous alumina templates can be first immersed in ethanol and then dipped into a TiO₂ sol at room temperature for 5 sec to—20 min. A dipping device operating at a rate of about 1-10 mm/sec can control the withdrawal speed in dip coating. After drying in the air at room temperature for 1-3 h, substrates can be heated in air at about 100° C. for about 10 minutes to about 2 h and about 400° C. for about 1-3 hours, at a rate of about 1-5° C./min, to obtain porous Al₂O₃/TiO₂ nanostructures.

Although, the preceding example describes filling the template pores with TiO₂ tubules, the template pores may alternatively be filled with an organic material such as those listed above.

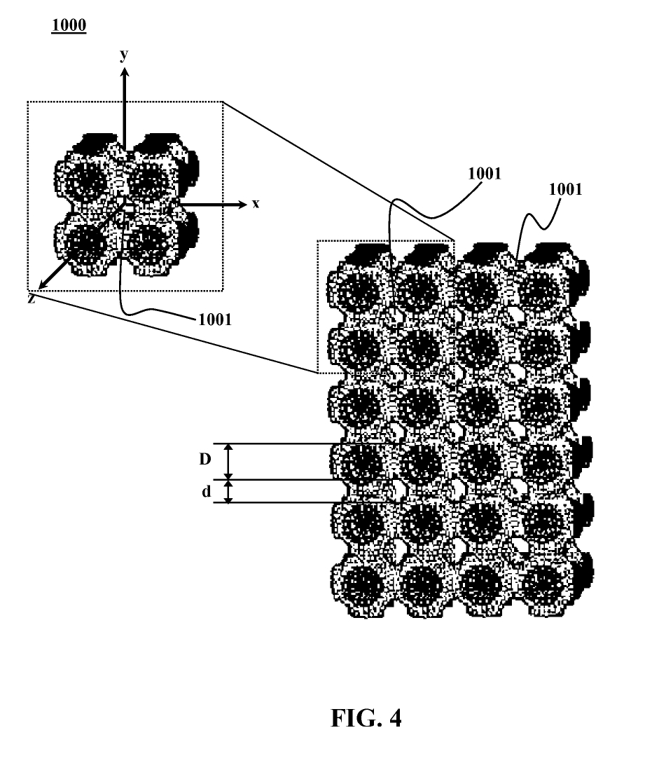

Optionally as seen in FIG. 4, the nanostructured porous layer 1000 can be used as a sacrificial template for making a device. The nanostructured porous layer 1000 may be removed after the pores 1001 are filled with the pore filling material leaving behind a nanostructured grid network having structures made of the pore-filling material. The structures can be roughly characterized as having diameter d and neighboring structures are separated by a distance of approximately D measured e.g., by thickness of the pore walls. Empty spaces between the structures can then be filled with a network filling material having complementary charge transfer properties with respect to the pore filling material that forms the structures. In such a case, pores with greater wall thickness D and smaller diameter d may be desirable in order to increase the spacing between the structures.

In order to further improve moisture resistance and scratch resistance, a fluorine resin may be laminated to the anti-reflection coating as a surface protecting layer. For example, tetra-fluoro ethylene copolymer (TFE, Du Pont TEFLON), copolymer of tetra-fluoroethylene and ethylene (ETFE, Du Pont TEFZEL), polyvinyl fluoride (Du Pont TEDLAR), polychlorofluoroethylene (CTFEC, Daikin Industries Neoflon) are cited. Weather resistance can also be improved by adding a well-known UV absorber. The protective layer may also include nitrides, oxides, oxynitrides or other inorganic materials that protect against exposure to water or air. In particular, the protective layer may be a multi-layer stack or a foil comprising a multi-layer stack of organic materials with inorganic dielectrics.

It should be understood that a variety of other techniques may be used to form pores or nanostructures in the spatial scales greater than 50 nm. Mesoporous templates can be produced using several different techniques. For example, organic or polymeric molecules can be intercalated and/or grafted within a mineral lamellar network. Mesoporous templates can be synthesized by electrocrystallisation of hybrid molecular assemblies, by impregnation of preformed inorganic gels, by synthesis from heterofunctional metallic alkoxides or silsesquioxannes, or through the connection of well-defined functional nanobuilding blocks. Mesoporous templates can also be fabricated by templated growth of inorganic or hybrid networks using organic molecules and macromolecules including surfactants, amines, alkyl ammonium ions, or amphiphilic molecules, as structure directing agents. Templated growth can also be done with nanoparticles followed by removal of the nanoparticles. Furthermore, mesoporous templates can be fabricated by bioengineered self-assembly, e.g., self-assembly of protein molecules for use as a deposition template, followed by removal of the template using a protease.

Optionally, each tubule pore can characterized by a tubule pore diameter d ranging from about 1 nm to about 200 nm, preferably between about 10 nm and about 200 nm, more preferably between about 10 nm to about 50 nm, still more preferably between about 20 nm and about 40 nm, most preferably about 30 nm. In general the tubule pore diameter d is less than the template pore diameter C.

Additional alternative embodiments include using different metal oxide precursors, such as zinc acetate (which ultimately forms ZnO columns in the porous template), WCl₆ (which ultimately forms WO₃), TEOS (which ultimately forms SiO₂), or any of a variety of other metal alkoxide precursors which each form corresponding metal oxide material in the template pores. The metal oxide precursors (and the resulting metal oxides) can be based on a central element X, which may be a transition metal, e.g., Ag, Au, Cd, Co, Cr, Cu, Fe, Ir, Mn, Mo, Nb, Ni, Sr, Ta, Ti, V, W, Y, Zn, Zr, etc. Other suitable central elements X include Al, B, Ba, Ce, Ge, Hf, In, La, Pb, Os, Se, Si, Sn, Sr, or Va.

### Deposition Techniques

A variety of solution-based coating techniques may be used to apply the above materials including but not limited to wet coating, spray coating, spin coating, doctor blade coating, contact printing, top feed reverse printing, bottom feed reverse printing, nozzle feed reverse printing, gravure printing, microgravure printing, reverse microgravure printing, comma direct printing, roller coating, slot die coating, meyerbar coating, lip direct coating, dual lip direct coating, capillary coating, ink-jet printing, jet deposition, spray deposition, ultrasonic spray deposition, and the like, as well as combinations of the above and/or related technologies. The surface of the substrate can be modified by the addition of a wetting agent to the solution, such as glycerine. The liquid may also be a dispersion or ink containing the aforementioned materials. Depending on such surface tension, application of the liquid onto the substrate may optionally be conducted upside down.

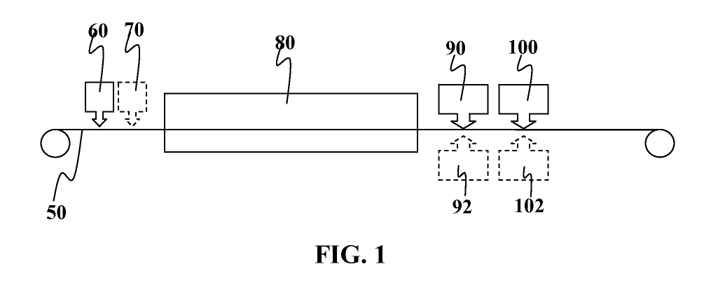

Embodiments of the precursor solution of the present invention may also be sprayed on to the target substrate. As seen in FIG. 1, by way of example and not limitation, the spray assembly 60 may use a single nozzle, two nozzles, or multiple nozzles to spray liquid across the width of the substrate 50. One or more of the nozzles may be ultrasonic nozzles. Ultrasonic nozzles are commercially available from manufacturers such as J D Ultrasonics of the United Kingdom. Optionally, the nozzles may be dual jet nozzles that are configured for atomizing liquid across a wide web such as that available from Wilson Spray Nozzle of Singapore. There may be one or more these wide web nozzles in assembly 60. Optionally, one or more of the nozzles may be a vortex nozzle, wherein the flow from the nozzle is such that a vortexing flow exits the nozzle to define a cone-shaped spray. Optionally, wide web and vortex nozzles may be used in combination. The spray assembly 60 may be sufficient to spray across a substrate 50 that may have a width of greater than 0.5 meters. Optionally, the spray assembly 60 may be sufficient to spray across a substrate 50 that may have a width of greater than 1.0 meters. Optionally, the spray assembly 60 may be sufficient to spray across a substrate 50 that may have a width of greater than 2.0 meters. Optionally, the spray assembly 60 may be sufficient to spray across a substrate 50 that may have a width of greater than 3.0 meters.

In another aspect, the amount of solution applied may be either a thin layer or it may be sufficient to create a bath of a depth of about 0.5 mm to about 5 mm in depth. Optionally, the bath may be about 0.5 microns to about 10 mm in depth. A shallow bath allows for sufficient coverage of the entire target surface of the substrate 50 while not substantially under-utilizing the raw material. The bath above the substrate 50 may be contained above the substrate 50 against a slidable seal and/or a movable seal. Optionally, the substrate 50 passes through a bath of the solution, wherein the substrate 50 may have a backside layer that can be removed.

Referring still to FIG. 1, a second deposition assembly 70 (shown in phantom) may also be used. This may be the same type of ultrasonic nozzle used in the solution deposition assembly 60. Optionally, it may one of the other types of deposition system such as but not limited to a vortex, wide-web, or other nozzle type different from the nozzle used in the solution deposition assembly 60. Optionally, the second deposition assembly 70 may include one or more of the following: wet coating, spray coating, spin coating, doctor blade coating, contact printing, top feed reverse printing, bottom feed reverse printing, nozzle feed reverse printing, gravure printing, microgravure printing, reverse microgravure printing, comma direct printing, roller coating, slot die coating, meyerbar coating, lip direct coating, dual lip direct coating, capillary coating, ink jet printing, jet deposition, spray deposition, and the like, as well as combinations of the above and/or related technologies. The solution from assembly 70 may be the same as that from assembly 60 or it may be a component used in the process such as the thiourea solution or the like.

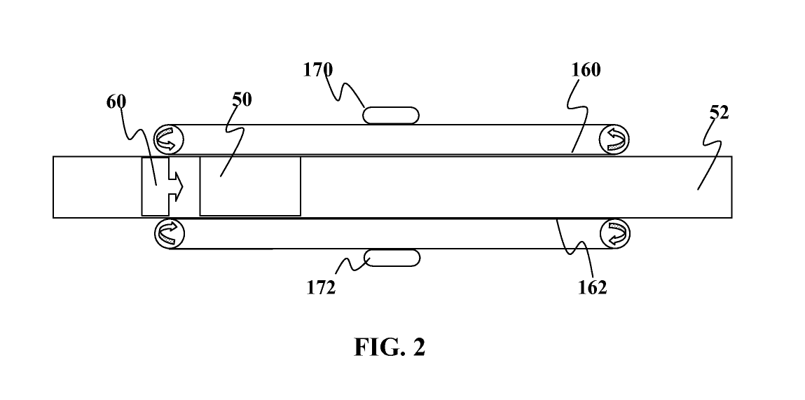

FIG. 2 shows yet another embodiment wherein a moving seal systems 160 and 162 which may be alongside the areas where the solution is deposited on the substrate 50. FIG. 2 is a top down view of the substrate 50 and the seals of the systems 160 and 162 will form side walls against the substrate 50 that allows the bath to be formed over the substrate 50. In the present embodiment, the substrate 50 may be carried on carrier web 52. In one embodiment, the seals of the systems 160 and 162 will also keep the bath or layer of solution on only one side of the substrate 50. The systems 160 and 162 may also be configured to have seals that move with the substrate 50. Other embodiments may have stationary seals that allow the substrate to slide along against it. Some embodiments may also include a dip in the substrate path (see FIG. 33) to help prevent the fluid or solution from flowing too far downweb or upweb. Scrubbing units 170 and 172 may also be included to clean the surface of the seal to remove and undesired build up that may prevent a good seal against the substrate 50. Other embodiments may use the units 170 and 172 to apply sealant to help the seal against the substrate 50.

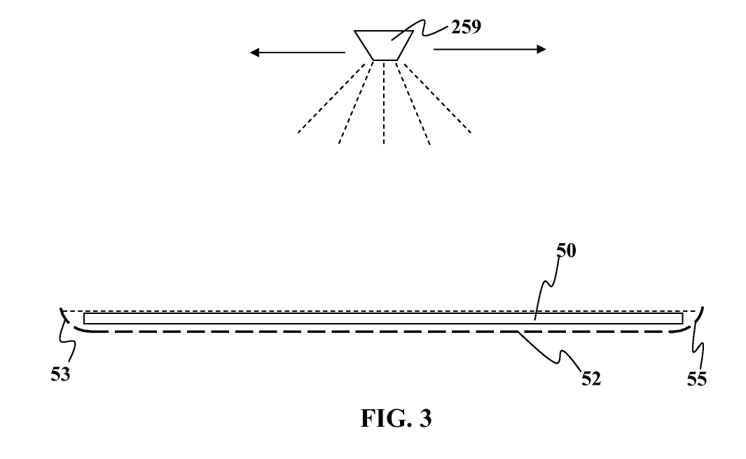

Referring now to FIG. 3, yet another embodiment of the present invention will now be described. This embodiment shows that instead of using seals, frames or other elements to help contain a fluid over the substrate 50, the edges 53 and 55 of a flexible carrier web 52 may be curved, curled, or angled upward. This defines a cupped or bowl-type cross-sectional shape that allows fluid to be filled therebetween as indicated by line 57 shown in phantom. The depth of the fluid between the upwardly curled edges 53 and 55 may be filled to a level below the upper edges, below the upper edges, and/or optionally over the upper edges. By way of example and not limitation, the depth of fluid over the substrate 50 may be in range from about 0.1 mm to about 20 mm. Optionally, in another embodiment, the depth of fluid over the substrate 50 may be in range from about 0.5 mm to about 10 mm. In the present embodiment, a fluid deposition assembly 259 may be used to form a covering of fluid over the substrate 50.

It should be understood that the fluid may be deposited by any of a variety of solution deposition techniques including, but not limited to, wet coating, spray coating, spin coating, doctor blade coating, contact printing, top feed reverse printing, bottom feed reverse printing, nozzle feed reverse printing, gravure printing, microgravure printing, reverse microgravure printing, comma direct printing, roller coating, slot die coating, meyerbar coating, lip direct coating, dual lip direct coating, capillary coating, ink jet printing, jet deposition, spray deposition, ultrasonic spray deposition, and the like, as well as combinations of the above and/or related technologies. FIG. 3 shows one embodiment wherein the fluid is sprayed onto the substrate 50. As seen in FIG. 3, the sprayer may be moved cross web and/or down web relative to the substrate 50 to obtain the desired depth or area coverage. The substrate 50 may be stationary or moving while being sprayed. The fluid may being deposited may be at a temperature that is substantially the same as that of the substrate 50. Optionally, in other embodiments, the fluid may be cooler than the substrate 50 or hotter than the substrate 50. Some embodiments may heat the fluid so that it is warmer than the ambient temperature. Some embodiments may use an air knife to cool and/or clean the substrate prior to deposition of the fluid.

It should be understood that the substrate 50 may be glass, soda lime glass, solar glass, tempered solar glass, tempered glass, untempered glass, a glass-foil solar module, a glass-glass solar module, a transparent rigid substrate, a transparent flexible substrate, a flexible module, or combinations of the foregoing. They may be processed in batch mode or roll to roll.

After deposition of the material on substrate 50, there may be further curing that occurs through UV and/or thermal processing. The UV or heating source will provide sufficient energy to cause the precursor materials to react.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. For example, with any of the above embodiments, although glass is the layer most often described as the top layer for the module, it should be understood that other material may be used and some multi-laminate materials may be used in place of or in combination with the glass. Some embodiments may use flexible top layers or coversheets. By way of nonlimiting example, the backsheet is not limited to rigid modules and may be adapted for use with flexible solar modules and flexible photovoltaic building materials. Embodiments of the present invention may be adapted for use with superstrate or substrate designs. This application may also be applied without requiring further tempering of the clear substrate. The coatings may applied in one or more layers over a tempered glass, tempered solar glass, full modules, un-tempered glass, or other transparent rigid substrate. Optionally, there may be a carrier on which discrete or pre-cut substrates comprising the precursor layers may be placed. The carrier may then carry these discrete or pre-cut substrates through the processing station(s). As part of the initial setup, the surface of the substrate to be processed may be cleaned prior to solution deposition. Dip coating of the substrate, bath techniques, and/or other solution deposition processes may also be used. It should also be understood that hydrophobic and/or superhydrophobic material may be used over the AR coating to prevent any pores in the AR coating from being filled with water which will degrade the AR ability of the coating. Optionally, polymers such as those with index of refraction of 1.2 to 1.5 may be used to fill surface pores on the coating. Optionally, those with an index of refraction closer to 1.2 may be used. Some polymers with suitable index of refraction may include but are not limited to all low refractive index polymers are amorphous fluorinated polymers by their structure. Champion data in three categories were introduced. By calculation, a polymer of fluorovinylether has the lowest refractive index. Among copolymers on the market, Teflon AF of DuPont has the lowest index, whereas Sitop of Asahi Glass Co., Ltd. is the homopolymer of the lowest refractive index.

Furthermore, those of skill in the art will recognize that any of the embodiments of the present invention can be applied to almost any type of solar cell material and/or architecture. For example, the absorber layer in solar cell 10 may be an absorber layer comprised of silicon, amorphous silicon, organic oligomers or polymers (for organic solar cells), bi-layers or interpenetrating layers or inorganic and organic materials (for hybrid organic/inorganic solar cells), dye-sensitized titania nanoparticles in a liquid or gel-based electrolyte (for Graetzel cells in which an optically transparent film comprised of titanium dioxide particles a few nanometers in size is coated with a monolayer of charge transfer dye to sensitize the film for light harvesting), copper-indium-gallium-selenium (for CIGS solar cells), CdSe, CdTe, Cu(In,Ga)(S,Se)2, Cu(In,Ga,Al)(S,Se,Te)2, other absorber materials, IB-IIB-IVA-VIA absorbers, and/or combinations of the above, where the active materials are present in any of several forms including but not limited to bulk materials, micro-particles, nano-particles, or quantum dots. The CIGS cells may be formed by vacuum or non-vacuum processes. The processes may be one stage, two stage, or multi-stage CIGS processing techniques. Additionally, other possible absorber layers may be based on amorphous silicon (doped or undoped), a nanostructured layer having an inorganic porous semiconductor template with pores filled by an organic semiconductor material (see e.g., US Patent Application Publication US 2005-0121068 Al, which is incorporated herein by reference), a polymer/blend cell architecture, organic dyes, and/or C60 molecules, and/or other small molecules, micro-crystalline silicon cell architecture, randomly placed nanorods and/or tetrapods of inorganic materials dispersed in an organic matrix, quantum dot-based cells, or combinations of the above. Many of these types of cells can be fabricated on flexible substrates. The substrate may be in the form of a commercially available sheet material such as but not limited to aluminum, steel, carbon steel, stainless steel, copper, Mo, or (C-, Au-, Ag-, Al-, or Cu-coated Steel Foil) or metal/alloy-coated plastic foils, including metal or metalized plastic substrates/foils that are planarized to reduce surface roughness.

Optionally, further improvements in AR function are possible by use of multilayer stacks that generate maximum destructive interference from the various surfaces within the stack. For example, a second quarter wavelength thick layer could be formed between a low index layer and another surface, where the reflections from three or more interfaces produce additional destructive interference. Mechanical etching at the nanoscale can create a rough surface which can function as an AR coating. For example, acid etching of soda lime glass can alter the index of refraction to around 1.27, due to the air pockets formed between the etched grooves and valleys in the glass. Optionally, more ordered nanostructured coatings can be used to approach an appropriately low refractive index where the coating material is thinned by air, so porosity is the tuning mechanism to achieve an optimum aggregate index of refraction. One approach to achieving this porosity is to sinter together similarly sized SiO2 nano-scale spheroids with a sol to promote inter-particle adhesion. Alternatively, a porous AR coating can be achieved with sols formed using aqueous systems with less than 1% organic components, where the AR properties are excellent, mechanical strength is high, and anti-abrasion properties are good. However, the coating formation process results in structural inhomogeneities as exemplified by streaking across the coated substrate, which can impact both the function and the appearance of the coated film. Optionally, another approach which may be combined with the present embodiments of the invention comprises using of two sizes of SIO2 nano-scale spheroids, where the smaller particles contribute both to an altered index of refraction and to good sintering (and thus uniform thickness with minimal streaking) due to the high chemical reactivity afforded by the high surface area to volume ration of very small particles (4-15 nm), and where the large particles contribute both to an altered index of refraction, to chemical

Leveraging their optical properties, these nanostructured pores could be used as photonic devices to manipulate light or the path that light takes in any of a variety of optical devices including but not limited to light filters, waveguides, mirrors, beam splitters, display screens, and the like.

Leveraging any of a combination of these properties, additional applications include the use of these nanostructured pores in information storage and processing applications, memory storage devices, memory retrieval devices, and the like.

Additionally, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a thickness range of about 1 nm to about 200 nm should be interpreted to include not only the explicitly recited limits of about 1 nm and about 200 nm, but also to include individual sizes such as but not limited to 2 nm, 3 nm, 4 nm, and sub-ranges such as 10 nm to 50 nm, 20 nm to 100 nm, etc. . . . .

The publications discussed or cited herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. All publications mentioned herein are incorporated herein by reference to disclose and describe the structures and/or methods in connection with which the publications are cited. For example, U.S. Provisional Application Ser. No. 60/986,442 filed Nov. 8, 2007 and U.S. Provisional Application Ser. No. 60/987,766 filed Nov. 13, 2007 are fully incorporated herein by reference for all purposes.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

1-38. (canceled)

39. A method of forming an anti-reflective film comprising:
forming a plurality of nanostructured porous layers wherein a porosity of each layer is tuned by at least one of the following: a sol-gel process, surfactant templation, and/or forming nanoporous coatings from polymeric precursors and using decomposition of the organic portion by heat, plasma or ozone;
wherein the nanostructured elements comprise of at least one of the following:
a pore, a filled-pore, and/or a channel.

40. The method of claim 39 wherein each of the layers comprises a regular array of structures, the structures having diameters between about 3 nm to about 50 nm with adjacent structures spaced between about 10 nm and about 50 nm.

41. The method of claim 39 wherein each of the layers comprises a regular array of structures, the structures having diameters between about 10 nm to about 50 nm with adjacent structures spaced between about 10 nm to about 50 nm.

42. The method of claim 39 wherein each of the layers comprises a regular array of structures, the structures having diameters between about 10 nm and about 500 nm with adjacent structures spaced between about 10 nm and about 500 nm.

43. The method of claim 39 further comprises substantially filling the pores with a pore-filling material to define a plurality of nanostructures in the porous layer.

44. The method of claim 39 using an organic pore-filling materials that is provided in the form of a process solution containing a precursor material and a solvent.

45. The method of claim 39 wherein each of the nanostructured porous layers are between about 50 nm and about 1 micron thick.

46. The method of claim 39 comprises filling the pores with a pore filling material to define structures in the nanostructured porous layer and removing the nanostructured porous layer leaving behind an array of structures with spaces between the structures.

47. The method of claim 39 wherein the nanostructured layers are formed using a self-assembly process.

48. The method of claim 39 wherein the nanostructured layers are formed using a sol-gel process.

49. The method of claim 39 wherein each of the nanostructured layers are sequentially formed using a solution deposition process.

50. The method of claim 39 wherein a plurality of the nanostructured layers are formed without sintering.

51. The method of claim 39 wherein the layers are formed by a single deposition step.

52. The method of claim 39 wherein the anti-reflective film is formed on individual solar cells.

53. The method of claim 39 wherein the anti-reflective film is formed on a substantially transparent front layer of a solar panel.

54. The method of claim 39 wherein the anti-reflective film is formed directly on a solar cell with no glass at all on the cell.

55-57. (canceled)

58. The device of claim 39 wherein the anti-reflective film comprises a multi-layer anti-reflective coating has a graded index of refraction.

59. The device of claim 39 wherein each of the nanostructured porous layers has a different index of refraction.

60. The device of claim 59 wherein the porosity of each of the porous layers is different from the porosity in any other layer to alter an index of refraction for that layer.

61. The device of claim 39 wherein the nanostructured porous layers define a three-dimensional porous network that provides an optical path which captures most of the visible light which enters the network.
